(19) United States
(12) Patent Application Publication
(10) Pub. No.: US 2021/0323780 A1
(43) Pub. Date: Oct. 21, 2021

(54) FULLY AUTOMATED END-LOADING OF A TRUCK

(71) Applicant: DÜCKER GROUP GMBH, Langenfeld (DE)

(72) Inventors: Peter DUECKER, Langenfeld (DE); Roland STEHR, Langenfeld (DE)

(21) Appl. No.: 17/263,359

(22) PCT Filed: Oct. 17, 2019
(86) PCT No.: PCT/EP2019/078266

§ 371 Date: Feb. 25, 2021

(30) Foreign Application Priority Data
Oct. 17, 2018 (DE) 10 2018 125 778.3

(51) Int. Cl. B65G 67/20

(52) U.S. Cl. CPC B65G 67/20

(57) ABSTRACT

Method and apparatus for the fully automated loading of a storage space with transport goods, in particular the fully automated loading of a storage space of a truck with cuboid transport goods, characterized in that in a first step the transport goods (of whatever kind) to be sent are deposited, in particular stacked, on a flat loading plate, in a second step the loading plate being moved until in front of the start of the storage space, and in a third step the loading plate being moved into the storage space.

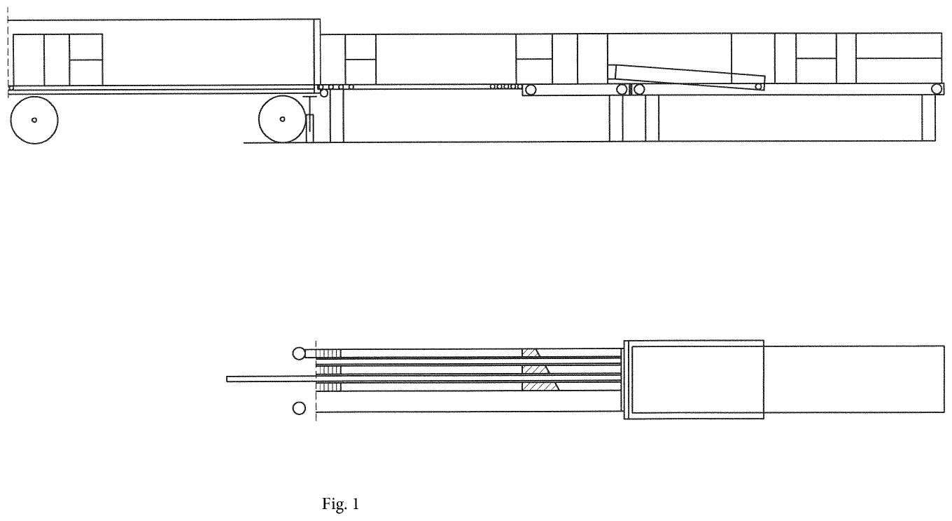

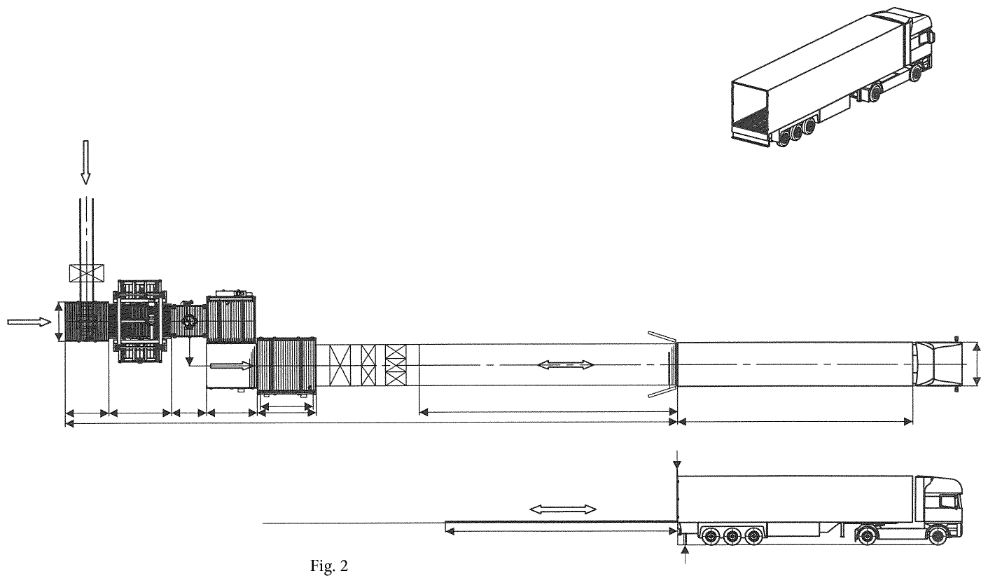

The invention relates to a method and an apparatus for fully automated loading a storage space with goods to be shipped, especially the fully automated loading of a storage space of a truck with rectangularly parallelepipedal goods to be shipped, according to the features of the introductory clause of the independent patent claim.

It is known that goods to be shipped, for example boxes, crates or the like, are loaded onto pallets, such as euro pallets. After that, each pallet is picked up by a forklift truck and transported to and deposited in the storage space, for example a semitrailer or truck cargo space. This method is repeated until the storage space is completely or partially filled with the cargo to be filled. This method is very complex, since the picking up, driving into the storage space, putting down the pallet, moving out of the storage space and so on must be carried out many times.

To speed up this method, it has already become known to use a forklift truck with long tines to accommodate the pallets, the length of the tines being approximately corresponding to the total length of the storage space. However, it is necessary here to order the shipping pallets with the goods to be shipped accordingly, of course in a row so that the multiple pallets arranged one behind the other sit on the long fork of the forklift truck. This does speed up the method of transporting the picked pallets into the storage space. However it is previously required to load the several pallets one behind the other such that the spaces between the fork tines (or skid racks) of the closely juxtaposed pallets are aligned so that they can be removed from the long tines or runners of the forklift and can be picked up.

The object of the invention is to provide an improved method and apparatus for carrying out this method, with which the loading of goods to be shipped into a storage space is done more quickly.

This object is attained in that, in a first step in the method, the goods to be shipped (of any type) are placed on a flat load plate, in particular stacked, and in a second step the load plate is moved to the open end of the storage space, and in a third step the load plate is moved into the storage space in a third step, and in a fourth step the load plate is moved out of the storage space again, but before this fourth step the goods to be shipped are secured at the open end of the storage space to prevent their movement out of the storage space when the load plate is retracted back out of the storage space.

In the apparatus for carrying out the method described above, the load plate is initially at an arbitrary location (for example within a logistics center) and the goods to be shipped are deposited, especially stacked, on this plate. This deposition takes place such that the inner shape of the storage space in which the goods are to be transported is taken into account and the goods to be shipped are placed on the loading platform so as not to project past this inner shape to ensure that the load plate can be moved into the storage space with the stored goods to be shipped in one step.

After a load plate with goods to be shipped has been prepared as described above, it is moved to the open end of the storage space and the longitudinal axis of the load plate is aligned with the longitudinal axis of the storage space.

The load plate is moved and aligned at the open end of the storage space with a suitable load transporter, for example again with a forklift truck, so it is not necessary that the load plate have tine or skid pockets.

After the load plate has been aligned, a suitable load transporter moves the load plate into the storage space. This movement continues until the front end of the load plate that is in the storage space is moved until it engages a stop in the storage space, preferably at the end thereof opposite its open end. After that, the load plate is preferably retracted back out of the storage space, while ensuring that the goods on the load plate do not move with the load plate, but are blocked from further movement. This blocking takes place in an advantageous manner by the appropriate load transporter that thus has two functions: (1) moving the load plate into the storage space and (2) blocking the goods on the load plate when the load plate is pulled out of the storage space. In a certain embodiment the load plate can be left in the storage space rather than moved out again, and is shipped together with the goods. This has the advantage that the goods shipped on the load plate can be unloaded from the storage space in a single step.

When the load plate is moved into the storage space by the load transporter, for example, the container in which the load plate with the cargo is to be moved into, it is supported on a sufficiently firm surface. The same applies to a trailer, in particular in the latter case the open back end of the trailer's storage space is braced to prevent the trailer (or the container or comparable holder for the goods to be shipped) from moving when the load plate with the goods to be shipped is moved into its storage space.

In a further embodiment of the invention, the load plate is provided with a bevel on the front. This has the advantage that the goods to be shipped are prepared accordingly and, if necessary, stacked until they at most reach the inner shape of the storage space. After this is done, the accordingly prepared and stacked goods are fixed and the load plate starting with its beveled front is pushed under the prepared goods so that they move onto the load plate. Then, as already described, the loaded plate can be aligned with and moved into the storage space.

It is ideal if the goods to be shipped are loaded onto the load plate and, if necessary, stacked and fill the maximum volume of the storage space. In addition, however, understandably, partial loads and thus partial loaded storage spaces are also conceivable. The goods do not have to be parallelepipedal, but it is also conceivable for example to load machine parts, trucks and other forms of goods to be shipped on the load plate.

In a simple embodiment, the load plate is a flat, continuous plate, for example made of wood, steel, aluminum, plastic or a combination of these materials, this list not being exhaustive. It is advantageous to remember that the load plate is light as compared to the loaded weight that can be pushed into the storage space by the load transporter. This flat design of the load plate has the advantage that, in contrast to pallets, no space for runners is required, so that the available installation space can be more efficiently exploited, in addition to the advantage of fast loading. It is also conceivable that the load plate is provided with rollers, cylinders, runners or the like on its underside, in order to be able to move into the storage space without significant friction. The same also applies for the preparation of the load plate before entering the storage space. Alternatively or in addition to the provision of rollers, cylinders or the like on the underside of the charging plate, these moving elements are set in respective cutouts of the load plate. In such a case, the load plate has a honeycomb structure. The flat load plate can also have a honeycomb structure without rollers, cylinders, or runners and the like.

The single FIGURE shows an apparatus for loading goods to be shipped into a storage space shown by way of example. The right third of the upper view shows that a load plate on which several goods to be shipped of different sizes have been stacked. This takes place, for example, regardless of the location where the storage space to be loaded is located. The middle third of the upper view shows that the loaded load plate is aligned with the storage space to be loaded (left third of the upper view, shown here as a trailer of a truck. A lever-like load transporter, which can also be moved lengthways, is aligned in the upper right representation with the prepared load plate with its goods to be shipped located on it and is brought to the position shown in the middle third of the upper view. After this has occurred, the load transporter causes the inward movement (displacement) of the prepared load plate into the storage space. During this movement, the load transporter is connected to the load plate, for example by engaging its rear end. After the load transporter has moved the load plate completely into the storage space, it pivots up a little, so that the storage space blocks the goods to be shipped and prevents them from moving out of the storage space when the load plate is retracted back out of the storage space. This means that the load plate is pulled out from under the goods to be shipped, which are already in the storage space so that the undersides of the lowest goods sit directly the upper face of the floor of the storage space.

In the manner described above with the load transporter according to the invention the loading method of individual goods to be shipped is made significantly faster than the known loading methods and load transporter.

1. A method for fully automated loading of a storage space with goods to be shipped, in particular the fully automated loading of a storage space of a truck with parallelepipedal goods to be shipped, the method comprising the steps of:
first, placing the goods to be shipped on a flat loading plate,
second, moving the loading plate with the goods thereon to an open end of the storage space, and
third, moving the loading plate with the goods thereon into the storage space.

2. The method according to claim 1, further comprising the step of;
fourth, moving the loading plate out of the storage space again, and,
before the fourth step and after the third step, blocking the goods to be shipped at the open end of the storage space against movement out of the storage space as the loading plate is moved out of the storage space during the fourth step.

3. The method according to claim 1, wherein during the first step a plurality of the loading plates are set up by placement of goods at respective locations and the goods to be shipped on that have been placed on these loading plates are be stored thereon prior to the second step.

4. The method according to claim 1, wherein the placing during the first step is done such that the inner shape of the storage space in which the goods to be shipped are is taken into account, and the goods are placed on the loading plate such that they not project beyond this inner shape.

5. The method according to claim 1, wherein, during the second step, the plate and goods thereon are moved toward the open end of the storage space and the longitudinal axis of the loading plate is aligned with a longitudinal axis of the storage space.

6. The method according to claim 5, wherein, after alignment of the loading plate, the loading plate is moved during the second step into the storage space until an end of the loading plate that is in the storage space engages a stop in the storage space.

7. (canceled)

8. An apparatus for fully automated loading of a storage space of a truck with parallelepipedal goods to be shipped, according to claim 1.

9. The apparatus according to claim 8, wherein the loading plate with has a front end provided with a bevel.

10. The apparatus according to claim 9, wherein the loading plate is a flat continuous plate.
